(19) United States
(12) Patent Application Publication
(10) Pub. No.: US 2021/0117725 A1
(43) Pub. Date: Apr. 22, 2021

(54) METHOD AND DEVICE FOR OBJECT DETECTION, AND NON-TRANSITORY COMPUTER READABLE STORAGE MEDIUM

(71) Applicant: Sensetime Group Limited, Hong Kong (CN)

(72) Inventors: Kun WANG, Hong Kong (CN); Jiabin MA, Hong Kong (CN); Zheqi HE, Hong Kong (CN); Hezhang WANG, Hong Kong (CN); Xingyu ZENG, Hong Kong (CN)

(73) Assignee: Sensetime Group Limited, Hong Kong (CN)

(21) Appl. No.: 17/113,721

(22) Filed: Dec. 7, 2020

Related U.S. Application Data
(63) Continuation of application No. PCT/CN2019/121300, filed on Nov. 27, 2019.

(30) Foreign Application Priority Data
May 27, 2019 (CN) 201910449107.7

(51) Int. Cl. G06K 9/62; G06N 3/08

(52) U.S. Cl. CPC G06K 9/6256; G06Q 50/26; G06N 3/08; G06K 9/6265

(57) ABSTRACT

A method and device for object detection, and a non-transitory computer readable storage medium are provided. The method includes the following. Object detection is performed on images of at least one second domain with a neural network to obtain detection results, where the neural network is trained with a first image sample set for a first domain. For at least one image among the images of the at least one second domain of which the detection result has a confidence level that is lower than a first threshold, the at least one image is assigned as an image sample in at least one second image sample set. At least one image sample is selected from the first image sample set and at least one image sample is selected from each of the at least one second image sample set.

### CROSS-REFERENCE TO RELATED APPLICATION(S)

This application is a continuation under 35 U.S.C. § 120 of International Application No. PCT/CN2019/121300, filed on Nov. 27, 2019, which claims priority under 35 U.S.C. § 119(a) and/or PCT Article 8 to Chinese Patent Application No. 201910449107.7, submitted on May 27, 2019, the disclosures of which are hereby incorporated by reference in their entireties.

### TECHNICAL FIELD

This disclosure relates to the technical field of deep learning, and particularly to a method and device for object detection, and a non-transitory computer readable storage medium.

### BACKGROUND

With the development of deep learning neural networks, the deep learning neural networks have been widely used in various fields, for example, a convolutional neural network is applied in object detection, and a recurrent neural network is applied in language translation, and so on.

At the beginning of training of the deep neural network, it is assumed that all data has been prepared. During training of the neural network, parameters of the neural network may be updated according to target tasks, and as a result the neural network can be successfully fitted to target data. When there are new tasks and new data, knowledge previously learned by the neural network may be rewritten during training, and thus the neural network may lose the performance for the previous tasks and data.

### SUMMARY

According to a first aspect, a method for object detection is provided in an implementation of the disclosure. The method includes the following. Object detection is performed on images of at least one second domain with a neural network to obtain detection results, where the neural network is trained with a first image sample set for a first domain. For at least one image among the images of the at least one second domain of which the detection result has a confidence level that is lower than a first threshold, the at least one image is assigned as an image sample in at least one second image sample set. At least one image sample is selected from the first image sample set and at least one image sample is selected from each of the at least one second image sample set. Object detection is performed on each selected image sample with the neural network to output a prediction result. A value of a network parameter of the neural network is adjusted according to the prediction result and a ground truth of each selected image sample.

In at least one implementation, the method further includes the following. Object detection is performed on the images of the at least one second domain with the neural network having an updated network parameter.

In at least one implementation, the at least one second domain is embodied as one second domain and the at least one second image sample set is embodied as one second image sample set. The amount of image samples in the first image sample set is larger than that of image samples in the second image sample set. A ratio of the amount of the at least one image sample selected from the first image sample set to the amount of the at least one image sample selected from the second image sample set falls within a first ratio range.

In at least one implementation, the at least one second domain is embodied as k second domains and the at least one second image sample set is embodied as k second image sample sets. For each second image sample set, the amount of image samples in the first image sample set is larger than that of image samples in the second image sample set, and a ratio of the amount of the at least one image sample selected from the first image sample set to the amount of the at least one image sample selected from the second image sample set falls within a second ratio range, where k is an integer greater than 1.

In at least one implementation, the following can be conducted after the neural network having the updated network parameter is obtained. The second image sample set is combined with the first image sample set to obtain a new first image sample set.

In at least one implementation, the following can be conducted after the new first image sample set is obtained. Image samples in the new first image sample set are filtered according to each processing result obtained by processing each image sample in the new first image sample set with the neural network having the updated network parameter and a ground truth of each image sample in the new first image sample set.

In at least one implementation, in terms of filtering the image samples in the new first image sample set according to each processing result obtained by processing each image sample in the new first image sample set with the neural network having the updated network parameter and the ground truth of each image sample in the new first image sample set, for each image sample in the new first image sample set: the image sample is inputted into the neural network having the updated network parameter to obtain a processing result of the image sample, a loss value of the image sample generated in processing the image sample with the neural network having the updated network parameter is determined according to the processing result and the ground truth of the image sample, and an image sample having a loss value that is smaller than a second threshold is discarded from the new first image sample set.

In at least one implementation, in terms of determining a confidence level of a detection result associated with an image, the detection result associated with the image is compared with a ground truth of the image to obtain the confidence level of the detection result.

According to a second aspect, a device for object detection is provided in an implementation of the disclosure. The device includes at least one processor and a non-transitory computer readable storage. The computer readable storage is coupled to the at least one processor and stores at least one computer executable instruction thereon which, when executed by the at least one processor, causes the at least one processor to execute the method of the first aspect.

According to a third aspect, a non-transitory computer readable storage medium is provided in an implementation of the disclosure. The non-transitory computer readable storage medium stores computer programs. The computer programs, when executed by a processor, cause the processor to execute the method of the first aspect.

### BRIEF DESCRIPTION OF THE DRAWINGS

In order to describe the technical solutions of the implementations of the disclosure more clearly, the following will briefly introduce the accompanying drawings that need to be used in the description of the implementations.

FIG. 1 is a schematic flow chart illustrating a method for object detection according to implementations of the disclosure.

FIG. 2 is a schematic flow chart illustrating a method for object detection according to other implementations of the disclosure.

FIG. 3 is a schematic flow chart illustrating a method for object detection according to other implementations of the disclosure.

FIG. 4 is a schematic diagram illustrating a training framework of a neural network used in a method for object detection according to implementations of the disclosure.

FIG. 5 is a schematic diagram illustrating a neural network being trained with a dual-pool data combination according to implementations of the disclosure.

FIG. 6 is a schematic diagram illustrating a neural network being trained with a multi-pool data combination according to implementations of the disclosure.

FIG. 7 is a schematic structural diagram illustrating a device for object detection according to implementations of the disclosure.

FIG. 8 is a schematic structural diagram illustrating an apparatus for object detection according to implementations of the disclosure.

### DETAILED DESCRIPTION

Technical solutions in the implementations of the disclosure will be described clearly and completely hereinafter with reference to the accompanying drawings in the implementations of the disclosure. Apparently, the described implementations are merely some rather than all implementations of the disclosure. All other implementations obtained by those of ordinary skill in the art based on the implementations of the disclosure without creative efforts shall fall within the protection scope of the disclosure.

It should be understood that when used in the specification and the appended claims, terms “including/comprising” and “containing” indicate the existence of the described features, integers, steps, operations, elements, and/or components, but do not exclude the presence or addition of one or more other features, integers, steps, operations, elements, components, and/or sets thereof.

It should be noted that the terms used in the specification of the disclosure are merely for the purpose of describing specific implementations rather than limiting the disclosure. As used in the specification and the appended claims of the disclosure, unless the context clearly indicates other circumstances, singular forms “a”, “an”, and “the” are intended to include plural forms.

It should be further understood that the term “and/or” used in the specification and appended claims of the disclosure refers to any combination of one or more of associated items listed and all possible combinations, and includes these combinations.

As used in this specification and the appended claims, the term “if” can be understood as “when”, “once”, “in response to determining”, or “in response to detecting” according to the context. Similarly, the expressing “if determined” or “if detecting [described condition or event]” can be understood as “once determined”, “in response to determining”, “once [described condition or event] is detected” or “in response to detecting [condition or event described]” according to the context.

A good neural network generally has a certain adaptive capability to be quickly applied in various places. However, since the capability of the neural network is limited and image sample data in different regions or scenes varies (for example, there are multiple buildings on urban roads, whereas multiple trees are on rural roads), problems may occur when the neural network trained with a single image sample data source is applied in other regions or scenes. For example, for road recognition, if image samples used in training are all urban roads, in actual applications, the urban roads may be recognized well, but for rural roads, errors may occur. A robust approach is to train different neural networks for different regions. However, for the method, it needs to collect and label new data, and the neural network needs to be retrained, which may be time-consuming and labor-intensive.

In view of the above, implementations of the disclose provide a method for object detection, which can enable a neural network to, in addition to maintaining an existing detection performance for an already trained scene, quickly obtain detection performance for objects in a new scene.

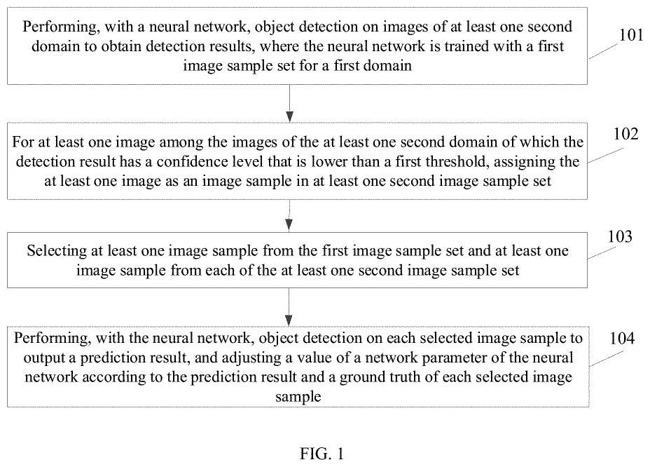

FIG. 1 is a schematic flow chart illustrating a method for object detection according to implementations of the disclosure. As illustrated in FIG. 1, the method begins at 101.

At 101, object detection is performed on images of at least one second domain with a neural network to obtain detection results, where the neural network is trained with a first image sample set for a first domain.

In implementations of the disclosure, the first domain and the second domain described above refer to two different application ranges of the neural network. Difference between the first domain and the second domain is as follows. \textcircled{1} The difference may exist in fields the first domain and the second domain can be applied, where the application fields may include a smart video field, a security monitoring field, an advanced driving assistant system (ADAS) field, an automatic driving (AD) field, and other fields. For example, the first domain is the security monitoring field, in which object A is detected. The second domain is the automatic driving field, in which object A or an object similar to object A is detected. \textcircled{2} The difference may exist in space/time. \textcircled{3} The difference may exist in data sources. For example, the first domain is a simulated environment, in which object A is detected. The second domain is a real environment, in which object A or an object similar to object A is detected. The above object may be a person, an animal, a motor vehicle, a non-motor vehicle, a traffic sign, a traffic light, an obstacle, or the like.

In implementations of the disclosure, the above-mentioned neural network may be any deep learning neural network. For example, the neural network may be a convolutional neural network for object detection, a recurrent neural network for speech recognition, a recursive neural network for scene recognition, or the like.

For any neural network, before the neural network is actually used, it is necessary to train the neural network to obtain an optimal weight parameter of the neural network under a scene, so that the neural network can be applied in the above scene. To train a neural network, it is necessary to collect image samples for training and label the image samples to obtain an image sample set, and then the neural network can be trained with the image sample set. After the neural network is trained, the neural network is tested. If a test result satisfies a condition, the neural network is actually put into use.

In implementations of the disclosure, the neural network (for the first domain) trained with the first image sample set refers to a neural network that has been trained with the first image sample set and can meet requirements on object detection when the neural network is applied in the first domain and performs detection on the images of the first domain. Thereafter, the neural network can be used to perform object detection on the at least one image of the second domain to obtain the at least one detection result. For example, after the neural network is trained, the neural network which is used for performing vehicle detection on a road image(s) of region A can be directly used for performing vehicle detection on a road image of region B.

In implementations of the disclosure, the neural network is trained with the first image sample set as follows. Image samples in the first image sample set are divided into a preset number of groups of image samples, and then the preset number of groups of image samples are used sequentially to train the neural network. Training the above neural network with each group of image samples is as follows. The group of image samples is inputted into the above neural network for forward propagation, to obtain output results from each layer of the neural network. According to labeling results of the image samples, error terms of each layer of the neural network can be reversely calculated. Thereafter, a weight parameter of the neural network is updated with the gradient descent method and a loss function.

In the above training process, the image samples are divided into several groups of image samples, and thus the parameter of the neural network is updated gradually per group. In this way, a same group of image samples jointly determines a gradient direction, and thus descending deviation does not easily occur, thereby reducing randomness. In addition, since the amount of image samples in a single group of image samples is much smaller than that of image samples in the whole image sample set, the amount of calculation is reduced. In one example, the weight parameter of the neural network is updated with the loss function, which is calculated as follows:

w=w−η∇Q(w)=w−ηΣᵢ₌₁ⁿ∇Q(w)/n (1)

where η represents a step size (also known as a learning rate), w represents the weight parameter, Q represents the loss function, and n represents the amount of image samples in each group of image samples.

At 102, for at least one image among the images of the at least one second domain of which the detection result has a confidence level that is lower than a first threshold, the at least one image is assigned as an image sample in at least one second image sample set. That is, when the confidence level of the detection result associated with one image of the second domain is lower than a first threshold, the image is assigned as an image sample of the second image sample set.

After the neural network performs object detection on an image of the second domain to obtain a detection result, the detection result associated with the image is compared with a ground truth of the image to obtain a difference value. The smaller the difference value, the closer the detection result to the ground truth of the image, and the more reliable the detection result. On the contrary, the larger the difference value is, the more the detection result deviates from the ground truth of the image, and thus the more unreliable the detection result is. The ground truth of the image may be labeling information in the image or the image (i.e., the real image).

Real scenes are relatively complex and contain various unknown situations. A typical data collection merely covers a very limited subset. After the neural network is trained with the first image sample set, since the first image sample set does not contain images of all scenes, detection results obtained by performing object detection on images of some scenes with the neural network can meet the needs, but for images of a scene which are not contained in the first image sample set, detection results may be inaccurate. Alternatively, since in the first image sample set image samples of each scene are not uniformly distributed, with the neural network false detection or missed detection may occur in some conditions for example, in a condition that detection is performed on road images of different regions.

Regarding the above problems, in implementations of the disclosure, after the neural network is trained with the first image sample set, the neural network continues to be used for performing object detection in a scene where the detection requirements are satisfied. For a scene where the detection requirements cannot be satisfied, when the object detection is performed on images of the scene, at least one image among the images is assigned as an image sample in the second image sample set on condition that a detection result associated with the at least one image is wrong. The detection result that is wrong refers to that a confidence level of the detection result is lower than the first threshold. In one example, the detection result associated with the image is compared with a ground truth of the image to obtain the confidence level of the detection result.

In one example, various manners can be used to determine which detection result has the confidence level that is lower than the first threshold. For example, the detection result associated with an image is manually compared with a corresponding correct result (that is, ground truth) of the image. Alternatively, a semi-automatic manner can be used, for instance, a relatively complex neural network is used to process the image, and a processing result obtained by the relatively complex neural network is compared with a processing result obtained by the neural network described above.

In one example, for each second image sample set, in addition to the images (where the confidence level of the detection result associated with each of the images is lower than the first threshold), image samples in the second image sample set can further include images having similar features to the images described above. Therefore, images having similar features to the images in the second image sample set can also be determined as image samples in the second image sample set. For example, training samples can be collected in the second domain and serve as the image samples in the second image sample set for training the neural network described above.

At 103, at least one image sample is selected from the first image sample set and at least one image sample is selected from each of the at least one second image sample set.

In an implementation, after the second image sample set for each second domain is obtained, at least one image sample is selected from the first image sample set and at least one image sample is selected from the second image sample set, so as to process each selected image sample with the neural network to obtain a prediction result. As a result, a value of a parameter of the neural network can be further optimized and adjusted according to the prediction result and the ground truth of each selected image sample. That is, the neural network is trained with image samples in the first image sample set and image samples in the second image sample set.

In at least one implementation, the at least one second domain is embodied as one second domain and the at least one second image sample set is embodied as one second image sample set. The amount of the image samples in the first image sample set is larger than that of the image samples in the second image sample set. A ratio of the amount of the at least one image sample selected from the first image sample set to the amount of the at least one image sample selected from the second image sample set falls within a first ratio range.

Since the amount of the image samples in the first image sample set is larger than that of the image samples in the second image sample set, the ratio of the amount of the at least one image sample selected from the first image sample set to the amount of the at least one image sample selected from the second image sample set falls within the first ratio range. To enable the performance parameter of the neural network to be quickly fitted to the second image sample set during training, each time image samples are selected from two image sample sets, the ratio of the amount of the at least one image sample selected from the first image sample set to the amount of the at least one image sample selected from the second image sample set is enabled to fall within the first ratio range. For example, to enable the neural network not only to maintain the previously obtained detection performance for the first domain, but also to quickly obtain the detection performance for the second domain, the first ratio range mentioned above may be about 1:1.

In another possible implementation, besides the case where the at least one second domain is embodied as one second domain, the at least one second domain may be embodied as multiple second domains, that is, there are multiple second domains. For example, the at least one second domain is embodied as k second domains and the at least one second image sample set is embodied as k second image sample sets. For each second image sample set, the amount of image samples in the first image sample set is larger than that of image samples in the second image sample set, and a ratio of the amount of the at least one image sample selected from the first image sample set to the amount of the at least one image sample selected from the second image sample set falls within a second ratio range, where k is an integer greater than 1. To enable the neural network to, in addition to maintaining the previously obtained detection performance for the first domain, quickly obtain the detection performance for each second domain, the amount of image samples selected from each second image sample set can be the same as that of image samples selected from the first image sample set, that is, the second ratio range may be about 1.

At 104, object detection is performed on each selected image sample with the neural network to output a prediction result, and a value of a network parameter of the neural network is adjusted according to the prediction result and a ground truth of each selected image sample.

In operations at 104, the value of the network parameter of the neural network being adjusted according to the prediction result and the ground truth of each selected image sample is an iterative process. The iterative process continues until difference between the output prediction result and the ground truth of each selected image sample meet conditions.

The ground truth of each selected image sample refers to labeling information of each selected image sample. For example, for an image sample for image detection classification, if an object in the image sample is a vehicle, the ground truth of the image sample is the vehicle in the image sample.

In deep learning, training means fitting. That is, the neural network is fitted to a given image sample data set. Different image sample data generally has different distributions. Target objects in the image sample data have large differences. Training with a new image sample data source may affect the performance for the original image sample data source, and the larger the difference, the more serious degradation in the performance.

The essence of training of the neural network is as follows. According to the prediction result associated with the image sample processed with the neural network and the ground truth (that is, the labeling information of the image sample or the real image) of the image sample, the value of the parameter of the neural network is continuously adjusted, to enable difference between the prediction result and the ground truth of the image sample to satisfy requirements. During training of the neural network, a frequency of accessing to a certain data source indicates a probability that the neural network can be fitted to the data source. The higher the frequency of accessing to a certain data source is, the easier the neural network is to fit to the data source, that is, the neural network has a good performance for the data source. When there is a new data source, if the training is merely conducted on the new data source, the neural network trained may be fitted to the new data source, and as a result, the neural network may lose the ability to be fitted to the previous data. Therefore, maintaining frequencies of accessing to new and old data sources at the same time is the key to train the neural network in the implementations of the disclosure.

In implementations of the disclosure, the first image sample set is old data and the second image sample set is new data. To enable the neural network to, in addition to maintaining the previously obtained performance for the first image sample set, be well fitted to the second image sample set, it is necessary to select image samples from both the first image sample set and the second image sample set, and then perform object detection on each selected image sample and adjust the parameter of the neural network according to a detection result and a corresponding ground truth (i.e., a labeling result or a real image) of each selected image sample.

In an implementation of the disclosure, to prevent the neural network from losing its detection performance for the first domain, after the second image sample set is collected, the first image sample set and the second image sample set are together used to train the neural network, to update and adjust the parameter of the neural network, so that the neural network can have detection performance for objects in images of the second domain, in addition to maintaining the detection performance for objects in images of the first domain. The specific training process in the implementation is similar to the foregoing training process (the neural network is trained merely with the first image sample set). That is, image samples are obtained from the image sample set per group. Different from the foregoing training process, in the training process of the implementation, each group of image samples (as a group of training samples) includes at least one image sample selected from the first image sample set and at least one image sample selected from the second image sample set. According to the above formula (1), the weight parameter of the neural network is updated until the weight parameter of the neural network reaches the optimum.

In the process of training the neural network with the image samples in the first image sample set and the second image sample set, if n image samples (the amount of image samples in each group of image samples) are randomly selected from the first image sample set and the second image sample set at each time, a probability that each image sample is sampled is n/N (N is the total amount of image samples in the first image sample set and the second image sample set), which may cause a problem. That is, for image sample data having a specific distribution, when the amount of the image sample data is relatively small, the image sample data may have little chance to participate in training, and thus their contribution to the training of the neural network may be diluted, thereby leading to the neural network unable to be fitted to the image sample data having the specific distribution. In this case, it is necessary to collect enough new image sample data to improve the performance. In addition, if the training is merely conducted on the new image sample data, the neural network may be fitted to the new image sample data, thereby leading to a decrease in the performance for the original image sample data.

In an alternative implementation, to solve the problem that improvement of the performance of the neural network is affected caused by that the amount of new image sample data is small, in the implementation of the disclosure, each group of image samples participating in the forward propagation includes image samples selected from the first image sample set and image samples selected from the second image sample set, where a ratio of the amount of the image samples selected from the first image sample set to the amount of the image samples selected from the second image sample set is a first ratio. For example, the ratio of the amount of the image samples selected from the first image sample set to the amount of the image samples selected from the second image sample set is 1:1, which can be adjusted according to actual conditions. As one example, if each group of image samples includes 32 image samples, 16 image samples may be selected from the first image sample set and 16 image samples may be selected from the second image sample set. In addition, since the amount of image samples in the first image sample set is different from that of image samples in the second image sample set, the number of times for which the image samples in the first image sample set participate in training is different from the number of times for which the image samples in the second image sample set participate in training. Therefore, according to the number of times, the ratio of the amount of the image samples selected from the first image sample set to the amount of the image samples selected from the second image sample set can be adjusted, so that an optimal value which is suitable for multiple image sample data sources can be found, which is more easily realized than a method of collecting a large amount of new image sample data.

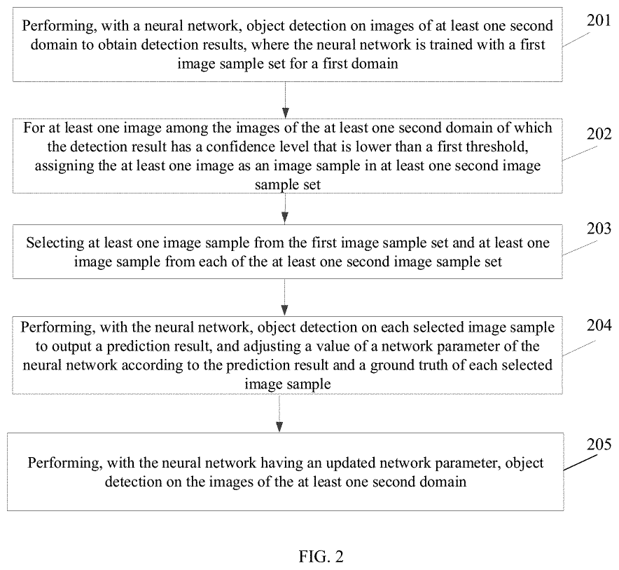

For the neural network having the updated network parameter, not only the detection performance for the first domain can be maintained, but also the detection performance for the second domain is improved, and thus object detection on images of the second domain can be performed with the neural network having the updated network parameter. A method for object detection is provided in an implementation of the disclosure. As illustrated in FIG. 2, the method begins at 201.

At 201, object detection is performed on images of at least one second domain with a neural network to obtain detection results, where the neural network is trained with a first image sample set for a first domain.

At 202, for at least one image among the images of the at least one second domain of which the detection result has a confidence level that is lower than a first threshold, the at least one image is assigned as an image sample in at least one second image sample set.

At 203, at least one image sample is selected from the first image sample set and at least one image sample is selected from each of the at least one second image sample set.

At 204, object detection is performed on each selected image sample with the neural network to output a prediction result, and a value of a network parameter of the neural network is adjusted according to the prediction result and a ground truth of each selected image sample.

At 205, object detection is performed on the images of the at least one second domain with the neural network having an updated network parameter.

In the implementation of the disclosure, since the network parameter of the neural network is updated according to both the first image sample set and the second image sample set, for the neural network having the updated network parameter, not only the detection performance for the first domain can be maintained, but also the detection performance for the second domain is improved. Therefore, results obtained by performing object detection on images of the second domain with the neural network having the updated network parameter are more accurate.

As can be seen, in implementation of the disclosure, after the detection results are obtained by performing object detection on the images of the at least one second domain, for at least one image among the images of the at least one second domain of which the detection result has a confidence level that is lower than a first threshold, the at least one image is determined as an image sample in at least one second image sample set. The neural network performs object detection on each of image samples selected from the first image sample set and each of the at least one second image sample set to output the prediction result. Thereafter, the value of the network parameter of the neural network is adjusted according to the prediction result associated with each new image sample (selected from each of the at least one second image sample set), the prediction result associated with each old image sample (selected from the first image sample set), and the ground truth of each selected image sample. That is, during training of the neural network, not only a new image sample set is added, but also the old image sample set is retained, such that the trained neural network can not only maintain the performance for the first domain, but also can be well fitted to the new image sample set. In other words, the neural network can quickly obtain the detection performance for objects in the new scene, in addition to maintaining the existing detection performance for the trained scene.

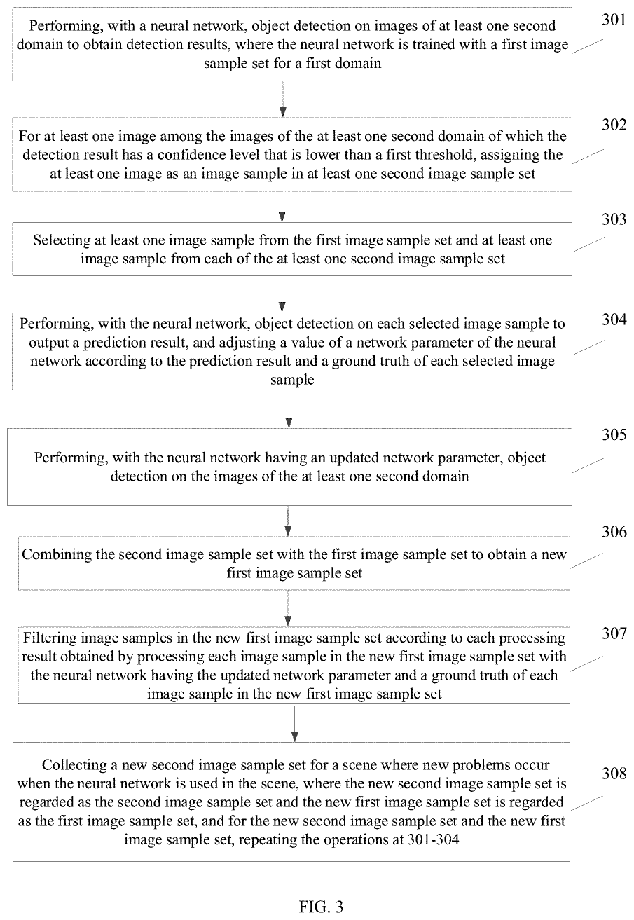

FIG. 3 is a schematic flow chart illustrating a method for object detection according to other implementations of the disclosure. As illustrated in FIG. 3, the method begins at 301.

At 301, object detection is performed on images of at least one second domain with a neural network to obtain detection results, where the neural network is trained with a first image sample set for a first domain.

At 302, for at least one image among the images of the at least one second domain of which the detection result has a confidence level that is lower than a first threshold, the at least one image is assigned as an image sample in at least one second image sample set.

At 303, at least one image sample is selected from the first image sample set and at least one image sample is selected from each of the at least one second image sample set.

At 304, object detection is performed on each selected image sample with the neural network to output a prediction result, and a value of a network parameter of the neural network is adjusted according to the prediction result and a ground truth of each selected image sample.

When difference between the ground truth of each selected image sample and the prediction result output from the neural network having the updated network parameter meets requirements, operations at 304 end.

At 305, object detection is performed on the images of the at least one second domain with the neural network having an updated network parameter.

After operations at 304 are completed, the neural network for object detection in the second domain can be upgraded. That is, object detection on the at least one image of the second domain can be performed with the neural network having the updated network parameter.

The following can be conducted after the operations at 304 are completed.

At 306, the second image sample set is combined with the first image sample set to obtain a new first image sample set.

In one example, operations at 305 and 306 can be executed in parallel, and there is no restriction on the execution sequence of thereof.

In the implementation of the disclosure, after the neural network is trained with the first image sample set and the second image sample set, the first image sample set and the second image sample set are combined as the new first image sample set. In this way, if new problems occur when the neural network described above is used in a scene, a new second image sample set can be collected for the scene. Thereafter, the new second image sample set can be regarded as the second image sample set, and the new first image sample set can be regarded as the first image sample set, such that for the new second image sample set and the new first image sample set, the above operations at 301-304 can be performed again. That is, the value of the network parameter of the neural network can be updated and adjusted for the new scene (i.e., a new second domain).

It can be understood that the first image sample set can be regarded as an old image sample set that has been used in training, and whenever the neural network needs to be applied in a new scene or field, a new image sample set (i.e., the above second image sample set or the new second image sample set) can be collected, such that the new image sample set and the old image sample set can be together used to train the neural network. In this way, the neural network can not only be adapted to the new scene or field, but also does not forget content learned before.

In the implementation of the disclosure, each time the neural network is trained with the new image sample set and the old image sample set (i.e., the first image sample set), the new image sample set and the old image sample set are combined as another old image sample set for next training, and thus the old image sample sets may become more and more as application scenes of the neural network increase. However, when the neural network can well process (detect, recognize, etc.) an image sample in the old image sample set, it means that the image sample is unable to provide useful information for training, so that before training, the image sample can be deleted from the old image sample set, to reduce unnecessary training and the amount of image samples in the old image sample set, thereby saving storage space.

Therefore, the method for object detection provided in the implementation of the disclosure further includes the following after the operations at 306 are completed.

At 307, image samples in the new first image sample set are filtered according to each processing result obtained by processing each image sample in the new first image sample set with the neural network having the updated network parameter and a ground truth of each image sample in the new first image sample set.

In implementation of the disclosure, after the new first image sample set is obtained by combining the second image sample set with the first image sample set, for each image sample in the new first image sample set, the image sample is inputted into the neural network having the updated network parameter to obtain a processing result of the image sample. According to the processing result obtained by processing the image sample with the neural network having the updated network parameter and the ground truth of the image sample, a loss value of the image sample generated in processing the image sample with the neural network having the updated network parameter can be calculated with a loss function for the neural network having the updated network parameter, and then an image sample having a loss value that is smaller than a second threshold is discarded from the new first image sample set. That is, the image samples having no contribution to training are deleted from the new first image sample set, to achieve the filtering of the image samples in the new first image sample set, thereby reducing unnecessary training and improving the efficiency of the training. It can be understood that the image samples in the old first image sample set and the second image sample set can be filtered first, so as to discard, from the old first image sample set and the second image sample set, the image samples having no contribution to training. After the image samples having no contribution to training are discarded, the first image sample set and the second image sample set which are filtered are combined to obtain the new first image sample set.

In one example, when the neural network having the updated network parameter is a convolutional neural network for object detection, the loss value of the image sample generated in processing the image sample with the neural network having the updated network parameter includes a classification loss value and a regression loss value. The specific calculation formula is as follows:

$$L ( x , c , l , g ) = \frac{1}{N} ( {L}_{c o n f} ( x , c ) + α {L}_{loc} ( x , l , g ) ) \qquad ( 2 )$$

where L(x,c,l,g) represents the loss value, L_{conf}(x,c) represents the classification loss value, L_{loc}(x,l,g) represents the regression loss value, x represents input image sample data, c represents a class of the input image sample data, l represents a predicted detection frame, g represents a label frame, N represents the amount of the input image sample data, and α represents a weight.

In one example, when the neural network is trained with the first image sample set and successfully applied in the first domain, it may also be desirable to apply the neural network in multiple second domains. When the neural network is applied in multiple second domains, multiple second image sample sets may be collected. In the process of training the neural network with the first image sample set and the multiple second image sample sets, image samples can be extracted from the first image sample set and the multiple second image sample sets per group to train the above neural network, where a ratio of the amount of image samples selected from the first image sample set to the amount of image samples selected from each of the multiple second image sample sets falls within a second ratio range. In each image sample set, the larger the amount of image samples involved in training, the better the neural network fitted to the image sample set. Therefore, in order to make the neural network fitted to the image sample sets more evenly, the second ratio range may be set to be about 1.

For example, assuming that the first image sample set includes 200 image samples and two second image sample sets each include 100 image samples, each time 60 image samples are taken from the first image sample set and the two second image sample sets to train the neural network. In each group of image samples, a ratio of image samples from the first image sample set to image samples from one second image sample set to image samples from the other second image sample set is 3:1:2. That is, for each group of image samples, 30 image samples are obtained from the first image sample set, 10 image samples are obtained from one second image sample set, and 20 image samples are obtained from the other second image sample set.

At 308, if new problems occur when the neural network is used in a scene, a new second image sample set is collected for the scene. The new second image sample set is regarded as the second image sample set, and the new first image sample set is regarded as the first image sample set, such that for the new second image sample set and the new first image sample set, the above operations at 301-304 can be performed again.

It can be understood that in the implementation of the disclosure, for the neural network that has been applied in the first domain, when the neural network is applied in the second domain and performs object detection on each image of the second domain, an image is determined as a second image sample, where a confidence level of the detection result associated with the image is lower than a first threshold. Multiple second image samples collected constitute the second image sample set. Thereafter, the neural network is trained with both the first image sample set (an image sample set used when the neural network is trained before applied in the first domain) and the second image sample set, in such a manner that the neural network can not only maintain the detection performance for the first domain, but also can improve the detection performance for the second domain. That is, the neural network can continue to learn new knowledge without forgetting the knowledge already learned.

In addition, after the neural network is trained with the first image sample set and the second image sample set, there may be new scenes or fields that the above neural network never relates to, so that a new second image sample set can be collected. In addition, the first image sample set and the second image sample set are combined as the new first image sample set. Thereafter, the above neural network can be continued to be trained with the new first image sample set and the new second image sample set.

Furthermore, each time the neural network is trained with the first image sample set and the second image sample set, the second image sample set is combined with the first image sample set to obtain another first image sample set for next training. Therefore, the first image sample sets may be more and more as the number of times of training increases. However, when the above neural network can well process (detect, recognize, etc.) an image sample in the first image sample set, it means that the image sample is unable to provide useful information for the training, so that before the training, the image sample can be deleted from the first image sample set, to reduce unnecessary training and the number of image samples in the first image sample set, thereby saving storage space.

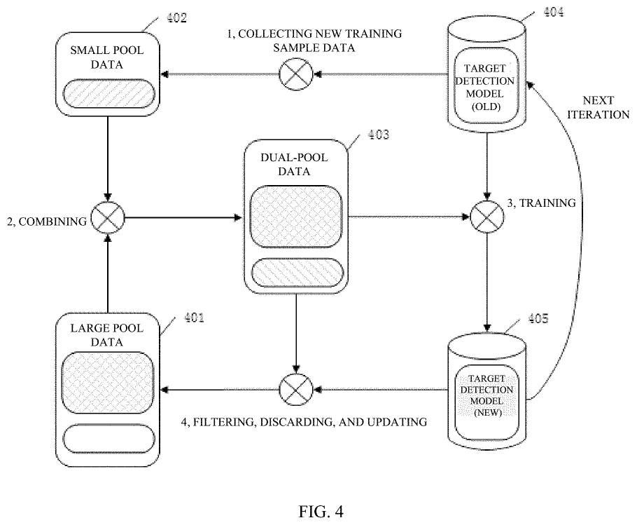

FIG. 4 is a schematic diagram illustrating a training framework of a neural network used in a method for object detection according to implementations of the disclosure. In FIG. 4, the training framework includes large pool data 401, small pool data 402, dual-pool data 403, an old-target detection model 404 (corresponding to the neural network applied in the first domain), and a new-target detection model 405 (corresponding to the neural network having the updated network parameter).

Large pool data: the large pool data is image sample data for training the neural network to be applied in the first domain, and the large pool data corresponds to the first image sample set mentioned above.

Small pool data: the small pool data is collected when the neural network is applied in the second domain, and the small pool data corresponds to the second image sample set mentioned above.

Dual-pool data: the dual-pool data is obtained by combining the large pool data 401 with the small pool data 402, and corresponds to the image sample set obtained by combining the second image sample set with the first image sample set.

Old-target detection model: the old-target detection model is trained with the large pool data. The old-target detection model corresponds to the neural network applied in the first domain, or corresponds to the neural network trained with the first image sample set and the second image sample set before the neural network is trained with the new first image sample set and the new second image sample set.

New-target detection model: the new-target detection model is trained with the large pool data and the small pool data. The new-target detection model corresponds to the neural network having the updated network parameter. That is, the new-target detection model corresponds to the neural network trained with the first image sample set and the second image sample set, or corresponds to the neural network trained with the new first image sample set and the new second image sample set.

In one example, the target detection model is trained with the large pool data to obtain an old neural network (i.e., the old-target detection model). The old neural network can be applied in a certain scene (such as the first domain) for object detection. When the old-target detection model is applied in the second domain, a new image sample set is collected for problems occur in application or testing. The collected new image sample set can be regarded as the small pool data. The small pool data and the large pool data are combined to obtain the dual-pool data, and then the old-target detection model continues to be trained with the dual-pool data to obtain the new-target detection model. The dual-pool data is filtered with the new-target detection model and a corresponding loss function to obtain new large pool data for next iteration.

FIG. 5 is a schematic diagram illustrating obtaining dual-pool data with dual-pool data combination and training a neural network with the dual-pool data according to implementations of the disclosure. In FIG. 5, the neural network is a convolution neural network. The large pool data and the small pool data are taken as input. The convolution neural network is trained with data selected from the large pool data and the small pool data, where a ratio of the amount of data selected from the large pool data to the amount of data selected from the small pool data is 1:1.

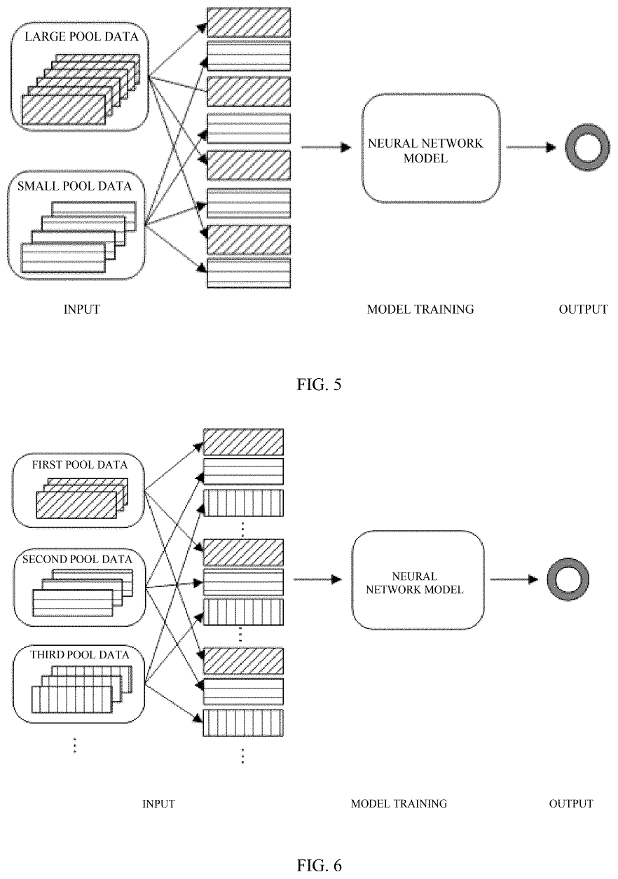

In addition to the above dual-pool scheme, a multi-pool data scheme can also be achieved according to an implementation of the disclosure, for example, a training method with a multi-pool data structure in FIG. 6. Data of different pools represents different image sample sets. The principle of the multi-pool data scheme is the same as that of the dual-pool scheme, which is to improve the participation of a certain data source in training. In the multi-pool data scheme, more data sources can be considered at the same time, and an optimal value which is suitable for multiple data distributions can be found. The specific process is similar to the method illustrated in FIG. 5, which is not repeated herein.

According to the training method of the implementation of the disclosure, the neural network can have the ability of continuous learning. That is, the neural network can continue to learn new knowledge without forgetting the knowledge already learned.

For example, there is a trained detection neural network which is actually put into use. The data used for training the neural network is from region A and the trained neural network is used for intelligent driving. Now for business needs, the detection neural network needs to be applied in region B. If the detection neural network is not trained with data from region B, the detection performance of the neural network for region B is not good. As one example, for vehicles unique to region B, a detector may not detect the vehicles. As another example, for some road cones in region B, misjudgment may also easily occur. However, if the training is merely conducted on the data from region B, due to forgetting, the detection performance of the neural network for region A may decrease. In view of the above, a dual-pool training method can be adopted. That is, videos of region B may be collected as small pool data, and then the small pool data cooperates with large pool data from region A, so that the neural network can be well fitted to the new scene (region B), in addition to maintaining the performance for the original scene (region A). When the training is completed, the small pool data can be combined with the large pool data, that is, an iteration of the neural network is completed.

For another example, there is a trained detection neural network which is actually put into use. The neural network is trained with general data and the trained neural network is used for security monitoring. When the trained neural network is applied in a remote region or a special scene, since there is a large scene difference, with the neural network false detection or missed detection may easily occur. Therefore, a dual-pool training method can be adopted. That is, videos of the new scene may be collected as small pool data, and then the small pool data cooperates with the large pool data, such that the performance of the detection neural network for the new scene can be quickly improved and overfitting can be avoided. When the training is completed, the small pool data can be combined with the large pool data, that is, an iteration of the neural network is completed.

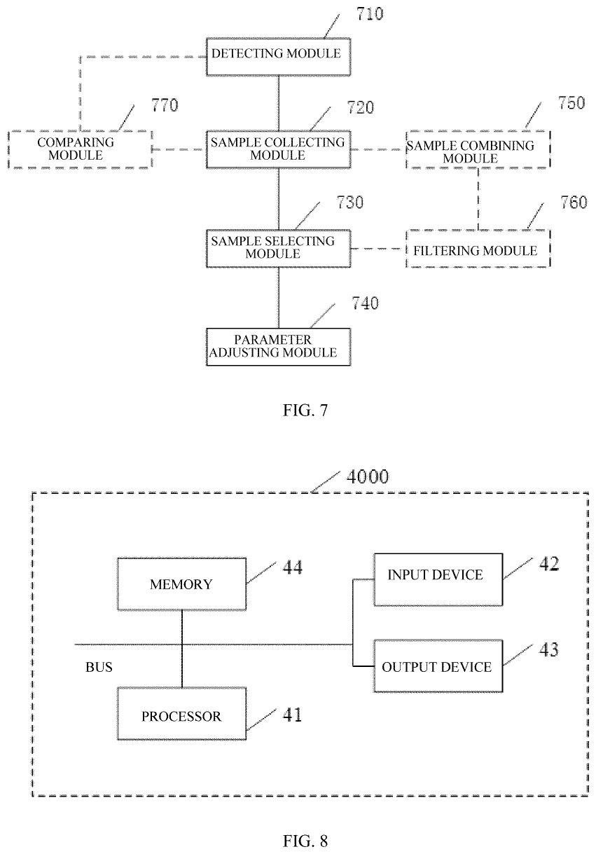

A device for object detection is provided according to an implementation of the disclosure. The device is configured to perform any of the methods described above. As illustrated in FIG. 7, FIG. 7 is a schematic structural diagram illustrating a device for object detection according to implementations of the disclosure. The device of the implementation includes a detecting module 710, a sample collecting module 720, a sample selecting module 730, and a parameter adjusting module 740.

The detecting module 710 is configured to perform, with a neural network, object detection on images of at least one second domain to obtain detection results, where the neural network is trained with a first image sample set for a first domain. The sample collecting module 720 is configured to assign, for at least one image among the images of the at least one second domain of which the detection result has a confidence level that is lower than a first threshold, the at least one image as an image sample in at least one second image sample set. The sample selecting module 730 is configured to select at least one image sample from the first image sample set and at least one image sample from each of the at least one second image sample set. The detecting module 710 is further configured to perform, with the neural network, object detection on each selected image sample to output a prediction result. The parameter adjusting module 740 is configured to adjust a value of a network parameter of the neural network according to the prediction result and a ground truth of each selected image sample.

In at least one implementation, the detecting module 710 is further configured to perform, with the neural network having an updated network parameter, object detection on the images of the at least one second domain.

In at least one implementation, the at least one second domain is embodied as one second domain and the at least one second image sample set is embodied as one second image sample set. The amount of image samples in the first image sample set is larger than that of image samples in the second image sample set. A ratio of the amount of the at least one image sample selected from the first image sample set to the amount of the at least one image sample selected from the second image sample set falls within a first ratio range.

In at least one implementation, the at least one second domain is embodied as k second domains and the at least one second image sample set is embodied as k second image sample sets. For each second image sample set, the amount of image samples in the first image sample set is larger than that of image samples in the second image sample set, and a ratio of the amount of the at least one image sample selected from the first image sample set to the amount of the at least one image sample selected from the second image sample set falls within a second ratio range, where k is an integer greater than 1.

In at least one implementation, the device further includes a sample combining module 750. The sample combining module 750 is configured to combine the second image sample set with the first image sample set to obtain a new first image sample set, after obtaining the neural network having the updated network parameter.

In at least one implementation, the device further includes a filtering module 760. The filtering module 760 is configured to filter image samples in the new first image sample set according to each processing result obtained by processing each image sample in the new first image sample set with the neural network having the updated network parameter and a ground truth of each image sample in the new first image sample set, after obtaining the new first image sample set.

In at least one implementation, the filtering module 760 includes a processing sub-module, a determining sub-module, and a deleting sub-module. The processing sub-module is configured to input, for each image sample in the new first image sample set, the image sample into the neural network having the updated network parameter, to obtain a processing result of the image sample. The determining sub-module is configured to determine, according to the processing result and the ground truth of the image sample, a loss value of the image sample generated in processing the image sample with the neural network having the updated network parameter. The deleting sub-module is configured to discard, from the new first image sample set, an image sample having a loss value that is smaller than a second threshold.

In at least one implementation, the device further includes a comparing module 770. The comparing module 770 is configured to compare a detection result associated with an image with a ground truth of the image to obtain the confidence level of the detection result.

As can be seen, in the implementation of the disclosure, for the neural network that has been applied in the first domain, when the neural network is applied in the second domain and performs object detection on each image of the second domain, an image is determined as a second image sample, where a confidence level of the detection result associated with the image is lower than a first threshold. Multiple second image samples collected constitute the second image sample set. The neural network performs detection on each of image samples selected from the first image sample set and the second image sample set to obtain a prediction result. Thereafter, a value of a network parameter of the neural network is adjusted according to the prediction result and a ground truth of each selected image sample. That is, during training of the neural network, not only a new image sample set is added, but also the old image sample set is retained, such that the trained neural network can not only maintain the detection performance for the first domain, but also improve the detection performance for the second domain. In other words, the neural network can quickly obtain detection performance for objects in the new scene, in addition to maintaining the existing detection performance for the trained scene.

FIG. 8 is a schematic structural diagram illustrating an apparatus for object detection according to implementations of the disclosure. The apparatus 4000 includes a processor 41. The apparatus 4000 may further include an input device 42, an output device 43, and a memory 44. The input device 42, the output device 43, the memory 44, and the processor 41 are connected with each other via a bus.

The memory includes but is not limited to a random access memory (RAM), a read only memory (ROM), an erasable programmable ROM (EPROM), or a portable ROM (such as, a compact disc ROM (CD ROM)). The memory is configured to store instructions and data.

The input device is configured to input data and/or signals. The output device is configured to output data and/or signals. The output device and the input device may be separated from each other or may be integrated with each other.

The processor may include one or more processors, for example, the processor includes one or more central processing units (CPU). In one example, the processor is a CPU, and the CPU may be a single-core CPU or a multi-core CPU. The processor may further include one or more dedicated processors. The dedicated processor may include a general processing unit (GPU), or a field programmable gate array (FPGA), which is used for accelerated processing.

The memory is configured to store program codes and data of network devices.

The processor is configured to invoke the program codes and data stored in the memory to perform the operations in the above method implementation. For specific details, reference may be made to the description in the method implementation, which is not repeated herein.

It can be understood that FIG. 8 merely illustrates a simplified design of the apparatus for object detection. In practical applications, the motion recognition device may further include other necessary components, including but not limited to any number of input/output devices, processors, controllers, memories, and the like. All motion recognition devices that can implement the implementations of the disclosure falls within the protection scope of the disclosure.

Implementations of the disclosure further provide a computer readable storage medium on which a computer program is stored. The computer program, when executed by a processor, is configured to perform any of the methods for object detection provided in the implementations of the disclosure. Implementations of the disclosure further provide a computer program product. The computer program product includes computer executable instructions. The computer executable instructions, when executed, are configured to perform any of the methods for object detection provided in the implementations of the disclosure.

Those of ordinary skill in the art can clearly understand that, for the convenience and conciseness of description, the specific working process of the above-described system, device, and unit can refer to the corresponding process in the foregoing method implementation, which is not be repeated herein.

In the implementations provided in the disclosure, it should be understood that the system, device, and method can be implemented in other manners. In addition, the unit division is only a logical function division, and there can be other manners of division during actual implementations, for example, multiple units or components may be combined or may be integrated into another system, or some features may be ignored or not performed. Coupling or communication connection between each illustrated or discussed component may be direct coupling or communication connection, or may be indirect coupling or communication connection among devices or units via some interfaces, and may be electrical connection, or other forms of connection.

The units described as separate components may or may not be physically separated, the components as display units may or may not be physical units. That is, they may be in the same place or may be distributed to multiple network elements. All or part of the units may be selected according to actual needs to achieve the purpose of the technical solutions of the implementations.

In the above implementations, the units/components may be implemented in whole or in part by software, hardware, firmware, or any combination thereof. When the units/components are implemented by software, they can be implemented in the form of a computer program product in whole or in part. The computer program product includes one or more computer instructions. The computer program instructions, when loaded and executed on the computer, are configured to perform the processes or functions according to the implementations of the disclosure in whole or in part. The computer may be a general-purpose computer, a dedicated computer, a computer network, or other programmable devices. The computer program instructions can be stored in the computer readable storage medium or transmitted through the computer readable storage medium. The computer program instructions can be sent from one website, computer, server, or data center to another website, computer, server, or data center via wired manners (such as coaxial cable, optical fiber, digital subscriber line (DSL)) or wireless manners (such as infrared, wireless, microwave, etc.). The computer readable storage medium may be any available medium that can be accessed by a computer or a data storage device such as a server or a data center that is integrated by one or more available media. The available medium can be a ROM, or a RAM, a magnetic medium (such as a floppy disk, a hard disk, a magnetic tape, a magnetic disk), an optical medium (such as, a digital versatile disc (DVD)), or a semiconductor media (such as, a solid state disk (SSD)), or the like.

The foregoing are merely specific implementations of the disclosure, but the scope of protection of the disclosure is not limited thereto. Any person of ordinary skill in the art can easily think of various equivalent modifications or substitutions within the technical scope disclosed in the disclosure, and these modifications or substitutions shall fall within the protection scope of the disclosure. Therefore, the protection scope of the disclosure shall be subject to the protection scope of the claims.

What is claimed is:

1. A method for object detection, comprising:
performing, with a neural network, object detection on images of at least one second domain to obtain detection results, wherein the neural network is trained with a first image sample set for a first domain;
for at least one image among the images of the at least one second domain of which a detection result has a confidence level that is lower than a first threshold, assigning the at least one image as an image sample in at least one second image sample set;
selecting at least one image sample from the first image sample set and at least one image sample from each of the at least one second image sample set;
performing, with the neural network, object detection on each selected image sample to output a prediction result; and
adjusting a value of a network parameter of the neural network according to the prediction result and a ground truth of each selected image sample.

2. The method of claim 1, further comprising:
performing, with the neural network having an updated network parameter, object detection on the images of the at least one second domain.

3. The method of claim 2, wherein the at least one second domain is embodied as one second domain and the at least one second image sample set is embodied as one second image sample set, wherein an amount of image samples in the first image sample set is larger than that of image samples in the second image sample set, and wherein a ratio of an amount of the at least one image sample selected from the first image sample set to an amount of the at least one image sample selected from the second image sample set falls within a first ratio range.

4. The method of claim 2, wherein the at least one second domain is embodied as k second domains and the at least one second image sample set is embodied as k second image sample sets, wherein:
for each second image sample set, an amount of image samples in the first image sample set is larger than that of image samples in the second image sample set, and a ratio of an amount of the at least one image sample selected from the first image sample set to an amount of the at least one image sample selected from the second image sample set falls within a second ratio range, wherein k is an integer greater than 1.

5. The method of claim 1, further comprising:
after obtaining the neural network having the updated network parameter:
combining the second image sample set with the first image sample set to obtain a new first image sample set.

6. The method of claim 5, further comprising:
after obtaining the new first image sample set:
filtering image samples in the new first image sample set according to each processing result obtained by processing each image sample in the new first image sample set with the neural network having the updated network parameter and a ground truth of each image sample in the new first image sample set.

7. The method of claim 6, wherein filtering the image samples in the new first image sample set according to each processing result obtained by processing each image sample in the new first image sample set with the neural network having the updated network parameter and the ground truth of each image sample in the new first image sample set comprises:
for each image sample in the new first image sample set:
inputting the image sample into the neural network having the updated network parameter, to obtain a processing result of the image sample;
determining, according to the processing result and the ground truth of the image sample, a loss value of the image sample generated in processing the image sample with the neural network having the updated network parameter; and
discarding, from the new first image sample set, an image sample having a loss value that is smaller than a second threshold.

8. The method of claim 7, wherein determining a confidence level of a detection result associated with an image comprises:
comparing the detection result associated with the image with a ground truth of the image to obtain the confidence level of the detection result.

9. A device for object detection, comprising:
at least one processor; and
a non-transitory computer readable storage, coupled to the at least one processor and storing at least one computer executable instruction thereon which, when executed by the at least one processor, causes the at least one processor to:
perform, with a neural network, object detection on images of at least one second domain to obtain detection results, wherein the neural network is trained with a first image sample set for a first domain;
assign, for at least one image among the images of the at least one second domain of which a detection result has a confidence level that is lower than a first threshold, the at least one image as an image sample in at least one second image sample set;
select at least one image sample from the first image sample set and at least one image sample from each of the at least one second image sample set;
perform, with the neural network, object detection on each selected image sample to output a prediction result; and
adjust a value of a network parameter of the neural network according to the prediction result and a ground truth of each selected image sample.

10. The device of claim 9, wherein the at least one processor is further configured to:
perform, with the neural network having an updated network parameter, object detection on the images of the at least one the second domain.

11. The device of claim 10, wherein the at least one second domain is embodied as one second domain and the at least one second image sample set is embodied as one second image sample set, wherein an amount of image samples in the first image sample set is larger than that of image samples in the second image sample set, and wherein a ratio of an amount of the at least one image sample selected from the first image sample set to an amount of the at least one image sample selected from the second image sample set falls within a first ratio range.

12. The device of claim 10, wherein the at least one second domain is embodied as k second domains and the at least one second image sample set is embodied as k second image sample sets, wherein
for each second image sample set, an amount of image samples in the first image sample set is larger than that of image samples in the second image sample set, and a ratio of an amount of the at least one image sample selected from the first image sample set to an amount of the at least one image sample selected from the second image sample set falls within a second ratio range, wherein k is an integer greater than 1.

13. The device of claim 9, wherein the at least one processor is further configured to:
combine the second image sample set with the first image sample set to obtain a new first image sample set, after obtaining the neural network having the updated network parameter.

14. The device of claim 13, wherein the at least one processor is further configured to:
filter image samples in the new first image sample set, according to each processing result obtained by processing each image sample in the new first image sample set with the neural network having the updated network parameter and a ground truth of each image sample in the new first image sample set, after obtaining the new first image sample set.

15. The device of claim 14, wherein the at least one processor configured to filter image samples in the new first image sample set, according to each processing result obtained by processing each image sample in the new first image sample set with the neural network having the updated network parameter and a ground truth of each image sample in the new first image sample set is configured to:
input, for each image sample in the new first image sample set, the image sample into the neural network having the updated network parameter, to obtain a processing result of the image sample;
determine, according to the processing result and the ground truth of the image sample, a loss value of the image sample generated in processing the image sample with the neural network having the updated network parameter; and
discard, from the new first image sample set, an image sample having a loss value that is smaller than a second threshold.

16. The device of claim 15, wherein the at least one processor is further configured to:
compare a detection result associated with an image with a ground truth of the image to obtain the confidence level of the detection result.

17. A non-transitory computer readable storage medium storing computer programs which, when executed by a processor, cause the processor to:
perform, with a neural network, object detection on images of at least one second domain to obtain detection results, wherein the neural network is trained with a first image sample set for a first domain;
for at least one image among the images of the at least one second domain of which a detection result has a confidence level that is lower than a first threshold, assign the at least one image as an image sample in at least one second image sample set;
select at least one image sample from the first image sample set and at least one image sample from each of the at least one second image sample set;
perform, with the neural network, object detection on each selected image sample to output a prediction result; and
adjust a value of a network parameter of the neural network according to the prediction result and a ground truth of each selected image sample.

18. The non-transitory computer readable storage medium of claim 17, wherein the computer programs, when executed by the processor, further cause the processor to:
perform, with the neural network having an updated network parameter, object detection on the images of the at least one second domain.

19. The non-transitory computer readable storage medium of claim 17, wherein the computer programs, when executed by the processor, further cause the processor to:
after obtaining the neural network having the updated network parameter,
combine the second image sample set with the first image sample set to obtain a new first image sample set.

20. The non-transitory computer readable storage medium of claim 19, wherein the computer programs, when executed by the processor, further cause the processor to:
after obtaining the new first image sample set,
filter image samples in the new first image sample set according to each processing result obtained by processing each image sample in the new first image sample set with the neural network having the updated network parameter and a ground truth of each image sample in the new first image sample set.
